(19) United States
(12) Patent Application Publication
(10) Pub. No.: US 2009/0305042 A1
(43) Pub. Date: Dec. 10, 2009

(54) METHOD FOR PREPARING LAYERED NANOPARTICLES, AND NANOPARTICLES OBTAINED

(76) Inventors: Patrick Moireau, Curienne (FR); Jean-Baptiste Denis, Paris (FR)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/158,598

(22) PCT Filed: Dec. 18, 2006
(86) PCT No.: PCT/FR2006/051373

§ 371 Date: Nov. 5, 2008

(30) Foreign Application Priority Data
Dec. 23, 2005 (FR) 0554076

(51) Int. Cl. B32B 5/16; C09K 3/00

(52) U.S. Cl. 428/403; 252/182.12

(57) ABSTRACT

The present invention relates to a method for preparing lamellar nanoparticles, the method including:
a) mixing a laminated material with a blowing agent chosen from polyols to obtain an expanded laminated material,
b) reacting the expanded laminated material with a grafting agent in the presence of water and an acid, said agent corresponding to the general formula

RₐXY₄₋ₐ
in which
   R represents a hydrogen atom or a hydrocarbon-based radical incorporating 1 to 40 carbon atoms, the R groups possibly being identical or different;
   X represents a silicon, zirconium or titanium atom;
   Y is an alkoxy group containing 1 to 12 carbon atoms, or a halogen; and
   a is equal to 1, 2 or 3; and
c) recovering at least one lamellar nanoparticle.

The invention relates to a method for preparing lamellar nanoparticles and to the resulting nanoparticles.

Mineral particles are widely used for reinforcing polymers of various types.

Such particles in the form of platelets are particularly sought after as they may be oriented in a given direction in the polymer to be reinforced, and thus give the polymer barrier properties, especially against water and gases. The particular shape of the particles and their arrangement approximately parallel to each other makes the migration of water and gases through the polymer matrix more difficult, thus slowing their diffusion.

Particles in platelet form are generally obtained from laminated materials, most often natural laminated materials, such as clays. Usually, the laminated material is subjected to one or more mechanical treatments, for example grinding or milling, and/or chemical treatments, for example ion exchange, in order to obtain particles having the desired dimension and particle size distribution. The particles obtained may then be modified to give them specific properties, for example to make their surface hydrophobic so as to further reduce the diffusion of water and gases through the polymers.

For example, EP-A-0 927 748 describes the preparation of hydrophobic clay particles that consists in contacting an aqueous suspension of clay with an organic compound incorporating silicon, such as an organosilane or an organosiloxane, in the presence of an acid and a water-miscible solvent, and in adding a water-immiscible solvent to effect the separation of the particles.

Recently, a growing interest has been shown for particles of reduced size, typically of less than 100 nanometers in their smallest dimension, which are referred to as “nanoparticles”.

In the same way as before, nanoparticles in platelet form are suitable for giving a barrier effect against water and gases when they are incorporated into a polymer. However, it has been observed that this effect is greater when the nanoparticles are in the form of individual platelets rather than aggregates of platelets.

One subject of the present invention relates to a method for preparing lamellar nanoparticles by treating a laminated material using a blowing agent able to be intercalated between the lamellae in order to separate them.

Another subject of the invention relates to a method for preparing graft-modified lamellar nanoparticles.

The method according to the invention is characterized in that it comprises the following steps consisting in:
a) mixing a laminated material with a blowing agent chosen from polyols,
b) reacting the expanded laminated material with a grafting agent in the presence of water and an acid, said agent corresponding to the general formula

RₐXY₄₋ₐ
in which
   R represents a hydrogen atom or a hydrocarbon-based radical incorporating 1 to 40 carbon atoms, the R groups possibly being identical or different;
   X represents a silicon, zirconium or titanium atom;
   Y is an alkoxy group containing 1 to 12 carbon atoms, or a halogen; and
   a is equal to 1, 2 or 3; and
c) recovering the lamellar nanoparticles.

The term “laminated material” is understood to mean a mineral material made up of a plurality of approximately parallel lamellae having a thickness of a few nanometers. In general, the lamellae of such a material are fully or only partly linked together by hydrogen or ionic type interactions between the free hydroxyl groups present at the surface of the lamellae and the water and/or cations contained in the interlamellar space. The laminated material may be a natural material or one obtained by chemical synthesis.

The invention more particularly relates to laminated materials belonging to the group of clays and boehmites.

The term “clay” is to be considered here in its definition that is generally accepted by a person skilled in the art, namely that it defines hydrated aluminosilicates of general formula Al₂O₃.SiO₂.xH₂O, where x is the degree of hydration.

By way of example, mention may be made of mica type philosilicates, such as smectites, montmorillonite, hectorite, bentonites, nontronite, beidellite, volkonskoite, saponite, sauconite, magadiite, vermiculite, mica, kenyaite and synthetic hectorites.

Preferably, the clay is chosen from 2:1 type phyllosilicates, advantageously smectites. The particularly preferred clay is montmorillonite.

Many manufacturers supply such clays in powder form, of which the particles are made up of platelets stacked on top of each other like a deck of playing cards. If necessary, the particles may be treated in order to reduce their size and/or achieve the desired particle size distribution, for example via a mechanical treatment in a mixer operating at a high speed.

The clay may be a clay having undergone a calcination step, for example at a temperature of at least 750° C.

The clay may further be a clay modified, for example, by cationic exchange in the presence of an ammonium, phosphonium, pyridinium or imidazolinium salt solution, preferably incorporating one or more alkyl groups, and better still the monoalkyl derivatives of these salts.

Such modified clays are well-known and are commercially available.

The laminated material may further be a boehmite made of hydroxyalumina, more particularly a synthetic boehmite obtained by hydrothermal reaction from aluminum hydroxide that is in the form of platelets. Powdered boehmites are commercially available. If necessary, a mechanical treatment as described above for clays may be applied in order to reduce the size of the particles and/or to obtain the desired particle size distribution.

In step a) the laminated material is mixed with a blowing agent that is intercalated between the lamellae and increases the distance between them, which encourages their separation into individual platelets.

The blowing agent according to the invention is chosen from polyols, preferably diols, for example ethylene glycol, 1,3-propanediol, 1,4-butanediol and polyethylene glycols. Advantageously, the polyethylene glycols have a molecular weight of at most 1200 and better still at most 600.

The quantity of laminated material in the mixture may vary by a larger amount, from 10 to 70%, preferably 20 to 50%.

If necessary, the mixture may undergo an operation that helps separate the lamellae into platelets, for example a mechanical treatment in a device enabling the particles to be sheared at a high speed or by ultrasonic action.

The mixing is carried out by adding the laminated material to the polyol, with stirring, and by maintaining said mixing at room temperature, around 20 to 25° C., for a time sufficient for the polyol to penetrate between the lamellae and interact with the free hydroxyl groups of the material. In general, a contact time of at least ten or so minutes is necessary, preferably at least 2 hours and better still at least 6 hours.

The mixture may, in addition, contain an agent that helps disperse the laminated material, for example a polyalkoxylated compound, such as an ethoxylated/propoxylated alkylphenol, an ethoxylated/propoxylated bisphenol or an ethoxylated/propoxylated fatty alcohol, the number of ethylene oxide units varying from 1 to 50, preferably from 1 to 40 and the number of propylene oxide units varying form 0 to 40, preferably 0 to 15.

In step b), the expanded laminated material was reacted with a grafting agent in the presence of water and an acid.

The term “grafting agent” is understood here to mean a compound capable of forming covalent bonds with the hydroxyl groups of the laminated material, and the grafts making it possible to modify the surface of said material in order to give it specific properties, especially to confer a hydrophobic or hydrophilic nature on it.

In general, the water is added first so as to obtain a suspension of the expanded laminated material, then the grafting agent and an acid are added.

The quantity of water added varies from 5 to 90% by weight of the mixture, preferably 10 to 70%.

As previously indicated, the grafting agent is a compound of formula

RₐXY₄₋ₐ

in which
R represents a hydrogen atom or a hydrocarbon-based radical incorporating 1 to 40 carbon atoms, said radical possibly being saturated or unsaturated, linear, branched or cyclic, possibly containing one or more O or N heteroatoms or being substituted with one or more amino, carboxylic acid, epoxy or amido groups, and the R groups being identical or different;
X represents Si, Zr or Ti;
Y is an alkoxy group containing 1 to 12 carbon atoms, or a halogen, preferably Cl; and
a is equal to 1, 2 or 3.

Preferably, the grafting agent is an organosilane, advantageously an organosilane incorporating two or three alkoxy groups.

By way of example, mention may be made of γ-aminopropyltrimethoxysilane, γ-aminopropyltriethoxysilane, N-phenyl-γ-aminopropyltrimethoxysilane, N-styrylaminoethyl-γ-aminopropyltrimethoxysilane, γ-glycidoxypropyltrimethoxysilane, γ-methacryloxypropyltrimethoxysilane, γ-acryloxypropyltrimethoxysilane, vinyltrimethoxysilane, vinyltriethoxysilane, tert-butylcarbamoylpropyltrimethoxysilane and γ-(polyalkylene oxide)propyltrimethoxysilanes.

Preferably, γ-aminopropyltriethoxysilane, N-phenyl-γ-aminopropyltrimethoxysilane, N-styrylaminoethyl-γ-aminopropyltrimethoxysilane, γ-glycidoxypropyltrimethoxysilane and γ-methacryloxypropyltrimethoxysilane are chosen.

The grafting agent is added in a quantity representing 15 to 75% by weight of the starting laminated material, preferably 30 to 70%.

In step b), the acid is added as the catalyst for the reaction between the grafting agents and the hydroxyl groups of the laminated material.

Any type of acid, mineral or organic, may be used. Preferably acetic acid is used. When a chlorosilane is used, the acid may be generated in situ by hydrolysis of the chlorosilane or by reaction of the chlorosilane with the hydroxyl groups present at the surface of the laminated material.

Preferably, the quantity of acid must make it possible to have a pH of the laminated material suspension between 1 and 6, preferably between 3 and 5 and better still around 4.

It is possible to carry out the reaction from step b) at room temperature, around 20 to 25° C., however the reaction time must be substantially reduced when the temperature is higher. As a general rule, the constituents from step b) are mixed at room temperature, then they are heated at a temperature that does not exceed 90° C.

In the suspension, it is possible to introduce an agent that helps to disperse the laminated material as described in step a) and/or a base for adjusting the pH, for example ammonium hydroxide.

In step c), the lamellar nanoparticles are recovered by any known means, for example by filtration or centrifugation, phase separation with addition of a water-immiscible solvent or evaporation of the water and where appropriate of the alcohol(s) resulting from the hydrolysis of the alkoxy groups of the grafting agent in step b).

The lamellar nanoparticles thus obtained are surface-modified by the residues of the grafting agent. They have a loss on ignition greater than 6%, preferably greater than 12% and better still greater than 16%.

These particles may undergo an additional treatment that contributes to separating the lamellae and thus makes it possible to increase the final proportion of low-thickness nanoparticles.

For example, it is possible to subject the nanoparticles, in suspension in a suitable medium, to a treatment allowing a strong shearing, for example by means of an Ultraturax® device, or by ultrasound. This treatment is preferably carried out by adding to the suspension an agent that helps disperse the nanoparticles, as defined previously, and/or a viscosity control agent, for example a polyvinyl acetate, a polyvinyl pyrrolidone, a hydroxymethylcellulose or a polyethylene glycol.

Another possible treatment consists in mixing the nanoparticles with a thermoplastic or thermosetting polymer resin, for example an epoxy resin, in an extruder and in emulsifying the extrudates in water.

The lamellar nanoparticles may be used especially for reinforcing polymer materials.

The following examples allow the invention to be illustrated without however limiting it.

### EXAMPLE 1

Introduced into a three-necked round-bottomed flask, topped with a cold-water circulating condenser and equipped with a thermometer, were 45 g of clay (Dellite® 67G; Laviosa Chimica Mineraria) and 300 g of polyethylene glycol (average molecular weight: 300).

The clay was a natural montmorillonite treated by cationic exchange with a quaternary ammonium salt.

After a few minutes, 100 g of water and 90 g of acetic acid (90% in water) were added to the mixture under stirring.

The mixture was heated at 50° C. under a sufficient stirring to obtain a good dispersion of the clay.

Next, 50 g of N-styrylaminoethyl-y-aminopropyltrimethoxysilane (Silquest® A1128; GE Silicones) were added. The pH of the suspension was equal to 5.

The suspension was heated under reflux for 4 hours, then cooled to room temperature and filtered.

The clay recovered was washed with water, dried at 105° C. for 1 hour, ground and dried again under the same conditions.

The clay contained more than 20% by weight of nanoparticles and had a loss on ignition equal to 17.4%.

### EXAMPLE 2

The conditions from example 1 were followed except that the clay was an unmodified natural montmorillonite (Dellite® HPS; Laviosa Chimica Mineraria) and the blowing agent was ethylene glycol.

Furthermore, after the step of heating under reflux, the clay recovered by filtration was washed with 500 ml of an aqueous 6 g/l sodium hydrogen carbonate solution and rinsed with 1 l of distilled water.

The clay produced contained more than 20% by weight of nanoparticles and had a loss on ignition equal to 14.9%.

### EXAMPLE 3

Introduced into the apparatus from example 1 were 165 g of N-styrylaminoethyl-γ-aminopropyltrimethoxysilane (Silquest® A1128; GE Silicones), 50 g of distilled water, 50 g of acetic cid and 100 g of propan-2-ol. The mixture was heated at 60° C. for 30 minutes to hydrolyze the silane.

Poured into a vessel containing 500 g of ethylene glycol, with vigorous stirring, were 180 g of clay (Dellite® 67G; Laviosa Chimica Mineraria). The mixture obtained was subjected to an Ultraturax® treatment for 10 minutes at 9000 rpm then it was introduced into the aforementioned apparatus.

The reaction mixture was heated under reflux for 5 hours, then it was cooled to room temperature and filtered.

The clay recovered was treated under the conditions from example 1. It had a loss on ignition equal to 26.7%.

### EXAMPLE 4

16.5 g of clay modified by a quaternary ammonium compound (Nanofil® 5; Süd-Chemie AG), 10 g of 2-amino-2-ethyl-1,3-propanediol, 20 g of polyvinyl alcohol (degree of hydrolysis: 88%; molecular weight: 22,000) and 300 g of distilled water were introduced into a vessel. The mixture was maintained under a strong stirring for at least 30 minutes in order to obtain a dispersion.

The dispersion was treated by Ultraturax® for 5 minutes at 6000 rpm, left at rest for 30 minutes and treated again by Ultraturax for 1 minute at 9000 rpm.

The dispersion and 200 g of water were introduced into the apparatus from example 1, followed by 50 g of acetic acid (90% in water). The mixture was heated at 50° C. under a sufficient stirring to obtain a good dispersion, then 50 g of γ-aminopropyltriethoxysilane (Silquest® A-1100; GE Silicones) were slowly added. The pH of the suspension was equal to 5.2.

The suspension was heated under reflux for 4 hours then cooled to room temperature and filtered.

The clay recovered was treated under the conditions from example 1. It had a loss on ignition equal to 24.4%.

### EXAMPLE 5

Introduced into the apparatus from example 1 were 50 g of clay modified by a quaternary ammonium compound (Nanofile® 5; Süd-Chemie AG), 200 g of polyethylene glycol (average molecular weight: 300) and 10 g of polyvinyl alcohol (degree of hydrolysis: 88%; molecular weight: 22,000).

After a few minutes, 250 g of water and 90 g of acetic acid (90% in water) were added to the mixture under stirring.

The mixture was heated at 50° C. with sufficient stirring to obtain a good dispersion of the clay. The dispersion was treated by Ultraturax® for 5 minutes at 6000 rpm, left at rest for 30 minutes, and treated again by Ultraturax for 1 minute at 9000 rpm.

Next, 30 g of γ-methacryloxypropyltrimethoxysilane (Silquest® A-174; GE Silicones), 15 g of N-(polyethylene oxyethylene)-N-β-aminoethyl-γ-aminopropyltrimethoxysilane (Silquest® A-1126; GE Silicones) and 10 g of silylated polyazamide (Silquest® A-1 387; GE Silicones) were slowly added to the dispersion obtained. The pH of the suspension was equal to 4.6.

The suspension was heated under reflux for 5 hours, cooled to room temperature and filtered.

The clay recovered was treated under the conditions of example 1. It had a loss on ignition equal to 35.9%.

1: A method for preparing lamellar nanoparticles, comprising:
a) mixing a laminated material with a blowing agent chosen from polyols to obtain an expanded laminated material,
b) reacting the expanded laminated material with a grafting agent in the presence of water and an acid, said agent corresponding to the general formula
RₐXY₄₋ₐ
in which
R represents a hydrogen atom or a hydrocarbon-based radical incorporating 1 to 40 carbon atoms, the R groups being identical or different;
X represents a silicon, zirconium or titanium atom;
Y is an alkoxy group containing 1 to 12 carbon atoms, or a halogen; and
a is equal to 1, 2 or 3; and
c) recovering at least one lamellar nanoparticle.

2: The method as claimed in claim 1, wherein the blowing agent is a diol.

3: The method as claimed in claim 2, wherein the diol is ethylene glycol, 1,3-propanediol, 1,4-butanediol or a polyethylene glycol.

4: The method as claimed in claim 1, wherein in step a) the quantity of laminated material represents 10 to 70% by weight of the mixture.

5: The method as claimed in claim 1, wherein the mixing in step a) is carried out at a temperature of around 20 to 25° C.

6: The method as claimed in claim 1, wherein R is a saturated or unsaturated, linear, branched or cyclic radical which may optionally comprise one or more O or N heteroatoms or be substituted with one or more amino, carboxylic acid, epoxy or amido groups.

7: The method as claimed in claim 6, wherein the grafting agent is an organosilane.

8: The method as claimed in claim 1, wherein the grafting agent is added in a quantity representing 15 to 75% by weight of the starting laminated material.

9. The method as claimed in claim 1, wherein the acid is added in a sufficient quantity so that the pH of the mixture from step b) is between 1 and 6.

10: The method as claimed in claim 1, wherein the laminated material, the grafting agent, the water and the acid from step b) are mixed at a temperature around 20 to 25° C., then heated at a temperature not exceeding 90° C.

11: The method as claimed in claim 1, wherein the laminated material is a clay or a boehmite.

12: At least one laminar nanoparticle obtained by the method as claimed in claim 1, wherein the at least one laminar nanoparticle has a loss on ignition greater than 6%.

13: The method as claimed in claim 1, wherein in step a) the quantity of laminated material represents 20 to 50% by weight of the mixture.

14: The method as claimed in claim 6, wherein the grafting agent is an organosilane having two or three alkoxy groups.

15: The method as claimed in claim 1, wherein the grafting agent is added in a quantity representing 30 to 70% by weight of the starting laminated material.

16: The method as claimed in claim 1, wherein the acid is added in a sufficient quantity so that the pH of the mixture from step b) is between 3 and 5.

17: At least one laminar nanoparticle obtained by the method as claimed in claim 1, wherein the at least one laminar nanoparticle has a loss on ignition greater than 12%.

18: At least one laminar nanoparticle obtained by the method as claimed in claim 1, wherein the at least one laminar nanoparticle has a loss on ignition greater than 16%.
